(19) United States
(12) Patent Application Publication
(10) Pub. No.: US 2025/0243689 A1
(43) Pub. Date: Jul. 31, 2025

(54) Straight Shank Adjustable Combination Lock

(71) Applicant: Rogers Joseph Selander, kingsland, GA (US)

(72) Inventor: Rogers Joseph Selander, kingsland, GA (US)

(21) Appl. No.: 19/038,847

(22) Filed: Jan. 28, 2025

(51) Int. Cl. E05B 37/02; E05B 73/00

(52) U.S. Cl. CPC E05B 37/02; E05B 73/0005

(57) ABSTRACT

Lock assembly 1 comprises of one straight shank 2 and removable tumbler assembly 3. Tumbler assembly 3 consist of two end caps 4, between which has at least two keyed tumblers 5 and one spacer 6.

### BACKGROUND

### Field of the Invention

This invention is related to locks, and more specifically to adjustable combination locks for securing multiple cables, chains, or the like.

### Description of the Related Art

There are existing locks being used by the public to secure items such as chain binders. Conventional U-shaped locks include a shank that is exposed. Exposure of the shank allows criminals and other to compromise the lock by cutting it. There are closed shank locks as well. However, closed shank locks can only secure one or two chains or cables at a time, which limit their use.

What differentiates the present invention is that shank it is a straight, wherein the shank is protected by the object being secured. Since the shank is protected and not exposed it can't be easily cut by those seeking to remove it.

Wherein the shank can adjustably extend through the second end cap aperture such that the shank head abuts a locked item to prevent access to the shaft, which will prevent cutting or tampering with the shaft

### SUMMARY

The present invention is an adjustable combination lock that includes at least one straight shank and a detachable lock assembly. The uniqueness of the design is that shank is straight and when adjusted properly It is protected by the object it is securing.

### DETAILED DESCRIPTION

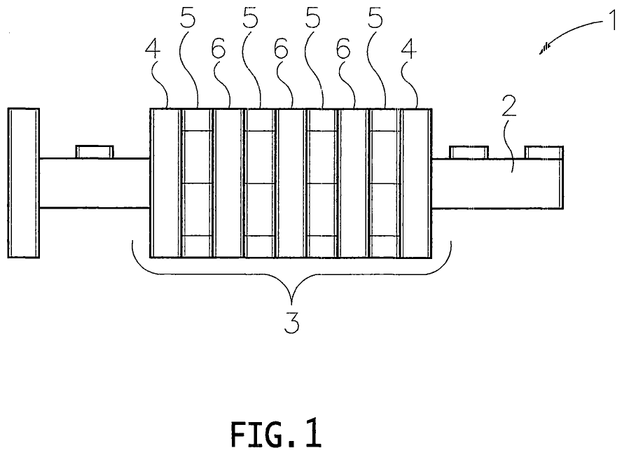

With reference to FIG. 1, and in one embodiment of the invention, an adjustable combination lock 1 is provided that includes a straight shank 2 and detachable combination lock assembly 3. Lock assembly 3 is detachable, so that assembly 3 may be removed and reattached during use.

1. This invention is an adjustable combination lock that includes at least one straight shank and a detachable lock assembly. The shank is inserted into the objects securing device, and then the tumbler assembly is slid onto the shank. With this configuration it prevents tampering with the shank.
